(19) United States
(12) Patent Application Publication
(10) Pub. No.: US 2010/0186779 A1
(43) Pub. Date: Jul. 29, 2010

(54) CONTROL APPARATUS FOR A WASHING STATION

(76) Inventor: Stefano Livoti, Santa Rufina (IT)

Correspondence Address: ARENT FOX LLP, 1050 CONNECTICUT AVENUE, N.W., SUITE 400, WASHINGTON, DC, 20036, US

(21) Appl. No.: 12/444,787

(22) PCT Filed: Oct. 9, 2007
(86) PCT No.: PCT/IT07/00703

§ 371 Date: Mar. 12, 2010

(30) Foreign Application Priority Data
Oct. 9, 2006 (IT) RM2006A000541

(51) Int. Cl. B08B 3/00

(52) U.S. Cl. 134/102.2

(57) ABSTRACT

The present invention concerns a control apparatus for a washing station comprising at least one inlet (3, 4) for a first fluid, preferably water, connected to at least one selector valve (1), which is in turn connected to first hydraulic pipe means (5, 7, 9, 13, 17), provided with first venturi mixing means (11, 31), and to third hydraulic pipe means (15), the first and third hydraulic pipe means (15) being connected to at least one respective outlet (16), the apparatus being characterised in that the selector valve (1) is further connected to second hydraulic pipe means (6, 8, 10, 14, 18), provided with second venturi mixing means (12, 32), also connected to said at least one outlet (16).

The present invention concerns a control apparatus for a washing station that is capable, in a simple, reliable, efficient, precise, and inexpensive way, to operate according to different functions, being easily installable and adaptable to different operating needs.

Washing equipments are very diffused. Such equipments allow both treatment with water only, and addition of chemical products, such as for instance wet foam and dry foam.

In particular, equipments presently on the market are provided with a water inlet opening tap, a tap for selecting delivery of water only or delivery of water mixed with a chemical product, and possibly a tap (sometimes integrated into the previous one) for selecting between two chemical products. In this regard, such conventional equipments are provided with only one venturi device for mixing the chemical products.

More in detail, conventional washing equipments are connected to the water network (providing for cold or hot water), and washing (e.g. flow, disinfection, etc.) is carried out through a suitable jet gun, that sprays water with chemical product and/or foam, depending on the type of chemical product. Dilution of the chemical product is carried out through Venturi effect suction by means of a sole venturi device.

In particular, different types of washing equipments are classified on the basis of the resulting jet on the delivery gun, according to: low precision equipments, high precision equipments, and dry foam equipments.

In all these conventional equipments, the difference is given by the delivery system (i.e. by the type of gun or nozzle) and by the type of the used venturi device, that changes its shape depending on the use for which it is intended.

Even the percentage of dilution of the chemical product is obviously and strictly correlated to the structure of the used venturi device.

However, conventional washing equipments present some drawbacks, mainly due to the fact that they operate with a single venturi device.

First of all, they are not much flexible and uneasily adaptable.

Moreover, in the case when a plurality of chemical products may be mixed, there is the risk that these get in contact with each other before that they are diluted in water.

Also, conventional equipments capable to deliver dry foam are complex and expensive, since it is necessary to add further components for injecting compressed air in the proximity of the washing gun or nozzle, and it is necessary to use a suitable venturi device allowing a higher water flow.

Furthermore, conventional equipments do not allow a simple maintenance, requiring the use of special tools.

Hence, it is an object of the present invention to allow a washing equipment to operate according to different functions in a simple, reliable, efficient, precise, and inexpensive way.

Therefore, it is specific subject matter of this invention a control apparatus for a washing station comprising at least one inlet for a first fluid, preferably water, connected to at least one selector valve, which is in turn connected to first hydraulic pipe means, provided with first venturi mixing means connected to at least one respective outlet, and to third hydraulic pipe means connected to at least one respective outlet, the apparatus being characterised in that the selector valve is further connected to second hydraulic pipe means, provided with second venturi mixing means, connected to at least one respective outlet.

Always according to the invention, said first venturi mixing means, said second venturi mixing means, and said third hydraulic pipe means may be connected to at least one identical outlet.

Still according to the invention, said first venturi mixing means may comprise at least one venturi device, housed within at least one corresponding pipe closed by a, preferably removable, respective tap of said first hydraulic pipe means, said first hydraulic pipe means comprising at least one connection for at least one corresponding valve for intaking a second fluid.

Furthermore according to the invention, said second venturi mixing means may comprise at least one venturi device, housed within at least one corresponding pipe closed by a, preferably removable, respective tap of said second hydraulic pipe means, said second hydraulic pipe means comprising at least one connection for at least one corresponding valve for intaking a third fluid.

Always according to the invention, the third hydraulic pipe means may comprise a third delivery pipe, ending with said at least one outlet, provided with hydraulic connection means, the first and second hydraulic pipe means being connected to said hydraulic connection means through respective connecting means provided with respective non-return valve means.

Still according to the invention, respective fast coupling fitting means and respective closing means are connectable to said at least one inlet for the first fluid.

Furthermore according to the invention, the apparatus may further comprise hydraulic disconnection means, preferably connectable to said at least one inlet through fast coupling fitting means.

Always according to the invention, the apparatus may comprise further hydraulic pipe means, preferably connectable to said at least one outlet through fast coupling fitting means, provided with at least one first inlet for a fourth fluid, preferably compressed air, connectable to at least one outlet of means for delivering the fourth fluid, preferably provided with non-return valve means in correspondence with the outlet.

Still according to the invention, said further hydraulic pipe means is further provided with at least one second inlet for connection to pressure gauge means, said at least one second inlet being located before said at least one first inlet, and in that said means for delivering the fourth fluid comprises regulator means provided with pressure gauge means, connectable to said at least one second inlet of said further hydraulic pipe means, capable to regulate the pressure of the fourth fluid that is delivered so as to keep it higher than the pressure sensed by said pressure gauge means with which the regulator means is provided.

The present invention will be now described, by way of illustration and not by way of limitation, according to its preferred embodiments, by particularly referring to the Figures of the enclosed drawings, in which:

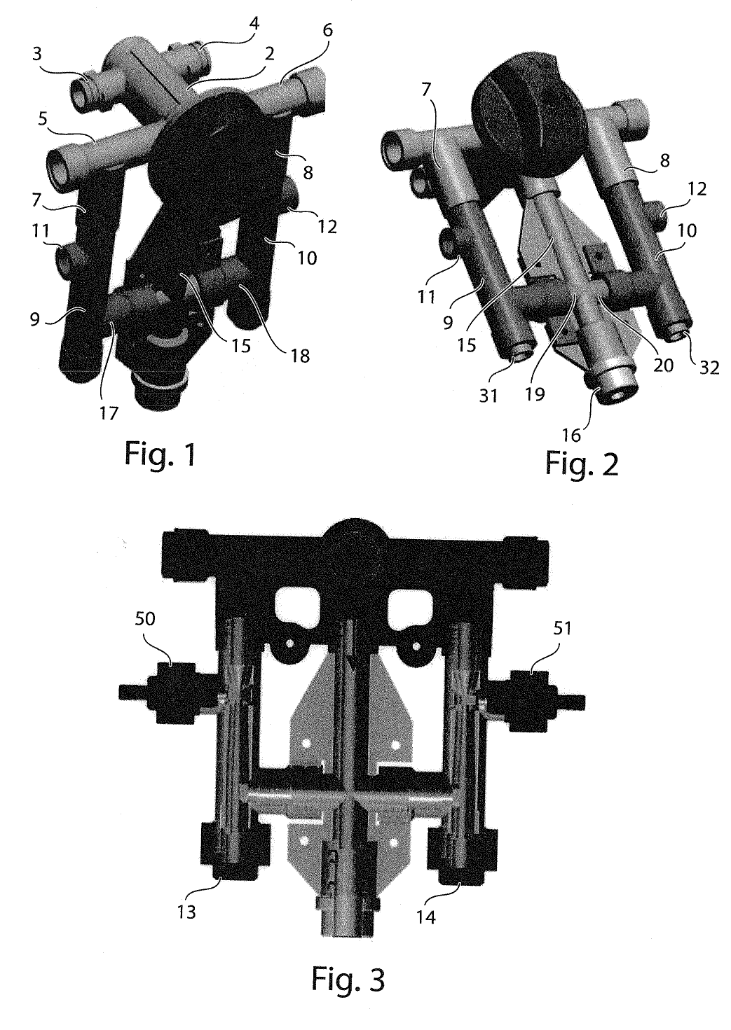

FIG. 1 shows a first perspective view of a first portion of the preferred embodiment of the control apparatus according to the invention;

FIG. 2 shows a second perspective view of the portion of FIG. 1;

FIG. 3 shows a front view in part section of the portion of FIG. 1;

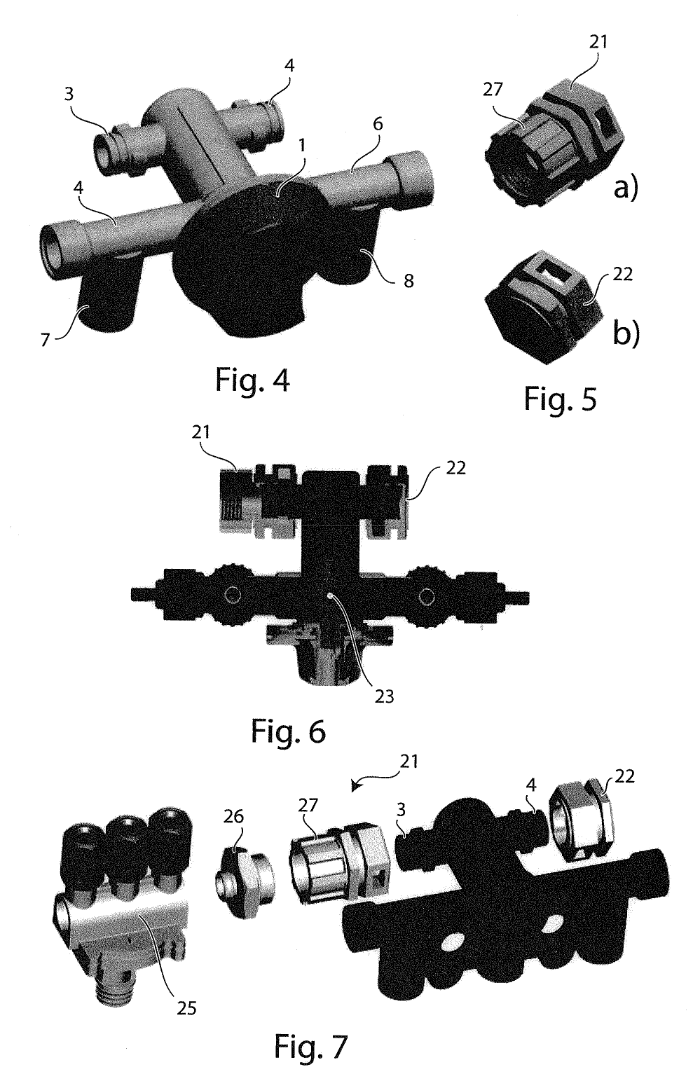

FIG. 4 shows a perspective view of a second portion of the apparatus of FIG. 1;

FIG. 5 shows a perspective view of two components connectable to the portion of FIG. 4;

FIG. 6 shows a top plan view in part section of the portion of FIG. 4;

FIG. 7 shows a perspective view of a third portion of the apparatus of FIG. 1 along with further components connectable thereto;

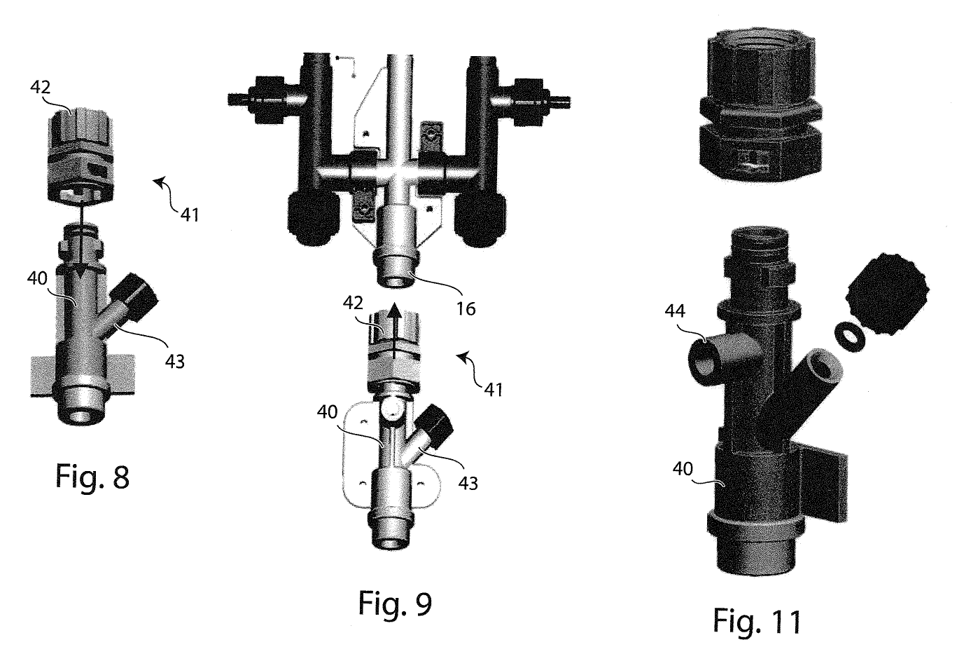

FIG. 8 shows a perspective view of a fourth portion of the preferred embodiment of the control apparatus according to the invention;

FIG. 9 shows a perspective view of a fifth portion of the preferred embodiment of the control apparatus according to the invention;

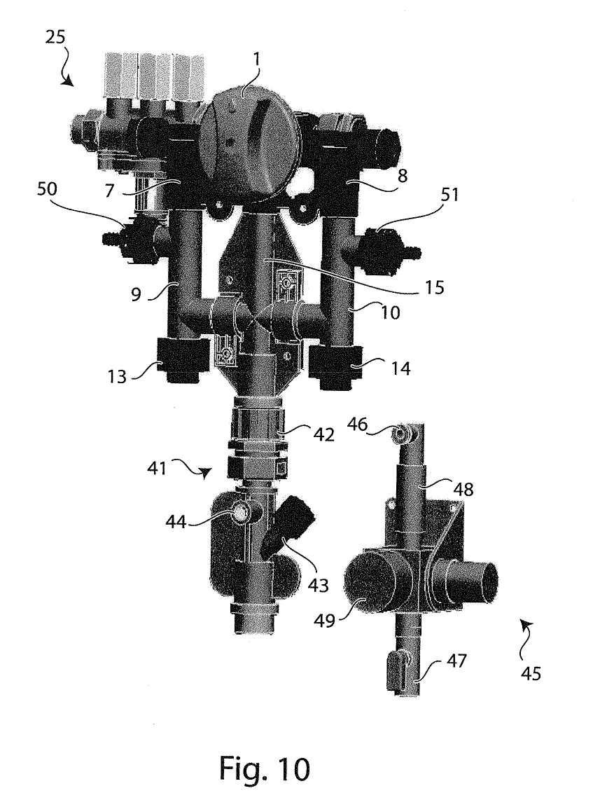

FIG. 10 shows a perspective view of the preferred embodiment of the control apparatus according to the invention; and

FIG. 11 shows a perspective view of a particular of FIG. 10.

In the Figures, alike elements are indicated by same reference numbers.

With reference to FIGS. 1-3, it may be observed that a preferred embodiment of the control apparatus according to the invention comprises a selector valve 1 for water inlet, which water comes from a T pipe 2 having a first and a second inlet, respectively 3 and 4. The selector valve 1 is connected to a first and a second delivery pipe, respectively 5 and 6, each one of which is connected to a respective offtake pipe, respectively 7 and 8. Each one of such first and a second pipes 7 and 8 is connected to a respective venturi device 31 and 32, which is housed in a corresponding pipe 9 and 10 provided with a connection, respectively 11 and 12, for a chemical product intake valve; in particular, each one of such first and second pipes 7 and 8 is closed by a respective end tap, respectively 13 and 14 (shown in FIG. 3), when it is not used in direct connection with a respective external delivery pipe, possibly connected to a gun for delivering the mixed product. In particular, by removing the end taps 13 and 14, the first and the second venturi devices 31 and 32 are extractable from the pipes 9 and 10, so as to render their maintenance or replacement easy. In this way, it is possible to easily adapt the control apparatus according to the invention to the user needs, by installing, depending on the needs, within the respective housing pipes 9 and 10, venturi devices, e.g., for low or high pressure, and/or for high dosages, and/or for dry foam.

The apparatus of FIGS. 1-3 further comprises a third delivery pipe 15 to which the selector valve 1 is capable to connect the inlet pipe 2. The third delivery pipe 15 ends with an outlet 16, to which the first and second pipes 9 and 10 are further connected, which pipes house the venturi devices 31 and 32, through respective integrated fittings 17 and 18 for connecting to respective connections 19 and 20 of the third delivery pipe 15.

As schematically shown in FIGS. 4-6, the apparatus of FIGS. 1-3 may be connected to a water source through the first and/or the second inlet 3 and 4 of the inlet pipe 2, depending on the user choice. By way of example, as shown in FIG. 6, a fast coupling fitting 21 with idle ring nut 27, also called “swivel”, may be connected to the first inlet 3, while a closing tap 22 may be connected to the second inlet 4.

The selector valve 1, preferably provided with a rotating knob, allows to run the system and to select the several operation steps without generating undesirable dosages. In fact, the configuration of the apparatus according to three channels, comprising the venturi devices 9 and 10 and the third delivery pipe 15, avoids a wrong use in the case where the user carries out undue operations.

The selector valve 1 is provided with a sole hole 23 for letting water pass, that forces the flow to cross one out of the three channels. In FIG. 6, such hole 23 is orientated in correspondence with the third delivery pipe 15 (for the rinsing function).

It is evident that such configuration prevents the control apparatus from simultaneously intaking two chemical products, since the location of the selector valve 1 before the two venturi devices 9 and 10 and the use of two distinct and separate channels for the two venturi devices 9 and 10 prevents the intaken products from mixing with each other. Moreover, after the pipes 9 and 10 housing the venturi devices 31 and 32, namely within the integrated fittings 17 and 18, a seat is present for inserting non-return valves.

Similarly, such configuration prevents the control apparatus from intaking a chemical product when on the contrary it operates according to the rinsing function, since also delivery of the only rinsing water occurs on a respective channel separate from the others.

The apparatus may be equipped with one or more disconnection devices located on the inlet(s) of the pipe 2 connected to the water network. In particular, the addition of such a disconnection device may occur also when the apparatus is already installed and without the use of special tools. In fact, as schematically shown by the application example of FIG. 7, wherein the second inlet 4 is closed by a tap 22, the use of the idle ring nut 27 of the swivel 21 connected to the first inlet 3 allows the swivel 21 to be coupled to the disconnection device 25 (preferably in conformity with UNI EN 1717 provisions), by means of a reduction unit 26 already screwed to the same micro BA device 25, by simply rotating the ring nut 27, once the device 25 has been put near the inlet 3.

As shown in FIGS. 8-11, the control apparatus according to the invention is preferably equipped with a device for producing foam, that may be coupled to the apparatus when the latter is already installed, by simply connecting a suitably developed module for introducing compressed air to an external delivery pipe.

With reference to FIGS. 8 and 9, it may be observed that the device for producing foam comprises a further pipe 40, to an end of which a further swivel 41 is fixed, the idle ring nut 42 of which is then screwed to the outlet 16 of the apparatus, preferably provided with brass thread.

The further pipe 40 is provided with a side inlet 43 for a pipe for delivering compressed air, and with an inlet 44 for a water pressure gauge, better shown in FIGS. 10 and 11. In particular, the pressure gauge inlet 44 is advantageously located at the point where the pressure has undergone all the head losses along its path, before arriving at the external delivery pipe. The pressure value of the air, introduced through the side inlet 43, must be higher than that sensed by the water pressure gauge, in order to avoid undesirable passages of water into the air pipe.

As shown in FIG. 10, the further pipe 40 is connected to a device 45 for delivering compressed air, provided with an outlet 46 that is connected to the side inlet 43 through a connecting pipe. The compressed air delivery device 45 is further provided with an inlet ball valve 47, which allows the air passage when operated, and with an outlet non-return valve 48, as well as with a regulator 49 with incorporated pressure gauge that is connected to the inlet 44 of the further pipe 40. In particular, opening the ball valve 47 allows the air to enter, which air, before getting to the outlet 46, encounters the regulator 49, which regulates its pressure so as to keep it higher than the water pressure sensed by the pressure gauge. The non-return valve 48 ensures protection of the regulator 49 should the water re-ascend due to instant pressure unbalances between the two fluids.

The control apparatus according to the invention is capable to operate according to different functions, such as: choice of the right operating pressure depending on the inlet pressure; high pressure washing on one of the two pipes 9 and 10 housing the venturi devices 31 and 32 and low pressure washing on the other one; washing with two high or low pressure products; washing with a high or low pressure product with two different dosage concentrations; washing with two foaming products; washing with a foaming product with two different dosage concentrations; washing with a high or low pressure product and a foaming product; delivery of dry foam by adding the further pipe 40 and the device 45 for injecting compressed air also with the already installed apparatus without the use of special tools.

The advantages offered by the control apparatus according to the invention are evident.

First of all, it may be equipped with disconnection devices located at the water inlet(s), and with devices for delivering compressed air, also with the already installed apparatus and without the use of special tools.

Moreover, the apparatus according to the invention avoids the wrong use in the case when the user carries out undue operations.

Also, it avoids the cross-contamination of dosed products, and it avoids undesirable product dosages.

Furthermore, the apparatus according to the invention is extremely flexible and adaptable to different operating needs, thanks to the fact that the venturi devices with which it is provided are easily extractable for their replacement and maintenance.

The present invention has been described, by way of illustration and not by way of limitation, according to its preferred embodiments, but it should be understood that those skilled in the art can make variations and/or changes, without so departing from the related scope of protection, as defined by the enclosed claims.

1. Control apparatus for a washing station comprising at least one inlet for a first fluid, preferably water, connected to at least one selector valve, which is in turn connected to first hydraulic pipe means, provided with first venturi mixing means connected to at least one respective outlet, and to third hydraulic pipe means connected to at least one respective outlet, the apparatus being characterised in that the selector valve is further connected to second hydraulic pipe means, provided with second venturi mixing means, connected to at least one respective outlet.

2. Apparatus according to claim 1, characterised in that said first venturi mixing means, said second venturi mixing means, and said third hydraulic pipe means are connected to at least one identical outlet.

3. Apparatus according to claim 1, characterised in that said first venturi mixing means comprises at least one venturi device, housed within at least one corresponding pipe closed by a, preferably removable, respective tap of said first hydraulic pipe means, said first hydraulic pipe means comprising at least one connection for at least one corresponding valve for intaking a second fluid.

4. Apparatus according to claim 1, characterised in that said second venturi mixing means comprises at least one venturi device, housed within at least one corresponding pipe closed by a, preferably removable, respective tap of said second hydraulic pipe means, said second hydraulic pipe means comprising at least one connection for at least one corresponding valve for intaking a third fluid.

5. Apparatus according to claim 1, characterised in that the third hydraulic pipe means comprises a third delivery pipe, ending with said at least one outlet, provided with hydraulic connection means, the first and second hydraulic pipe means being connected to said hydraulic connection means through respective connecting means provided with respective non-return valve means.

6. Apparatus according to claim 1, characterised in that respective fast coupling fitting means and respective closing means are connectable to said at least one inlet for the first fluid.

7. Apparatus according to claim 1, characterised in that it further comprises hydraulic disconnection means, preferably connectable to said at least one inlet through fast coupling fitting means.

8. Apparatus according to claim 1, characterised in that it further comprises further hydraulic pipe means, preferably connectable to said at least one outlet through fast coupling fitting means, provided with at least one first inlet for a fourth fluid, preferably compressed air, connectable to at least one outlet of means for delivering the fourth fluid, preferably provided with non-return valve means in correspondence with the outlet.

9. Apparatus according to claim 8, characterised in that said further hydraulic pipe means is further provided with at least one second inlet for connection to pressure gauge means, said at least one second inlet being located before said at least one first inlet, and in that said means for delivering the fourth fluid comprises regulator means provided with pressure gauge means, connectable to said at least one second inlet of said further hydraulic pipe means, capable to regulate the pressure of the fourth fluid that is delivered so as to keep it higher than the pressure sensed by said pressure gauge means with which the regulator means is provided.
